(19) United States
(12) Patent Application Publication
(10) Pub. No.: US 2005/0060063 A1
(43) Pub. Date: Mar. 17, 2005

(54) Automated item dispensing systems

(75) Inventors: Timothy Courtland Reichelt, Ashmore (AU); Robin Craig, Helensvale (AU)

Correspondence Address: MORRISON & FOERSTER LLP, 3811 VALLEY CENTRE DRIVE, SUITE 500, SAN DIEGO, CA, 92130-2332, US

(73) Assignee: GENESEARCH PTY LTD., Arundel (AU)

(21) Appl. No.: 10/660,896

(22) Filed: Sep. 11, 2003

(51) Int. Cl. G06F 17/00

(52) U.S. Cl. 700/244

(57) ABSTRACT

The invention relates to an automated item dispensing system that is capable of dispensing biological products. The system preferably comprises: (a) at least one dispenser (preferably a temperature controlled dispenser) capable of dispensing an item; (b) at least one local controller for controlling and monitoring a respective dispenser; (c) a central controller for receiving and processing electronic item orders from at least one user; and (d) a communication network for providing communication between said central controller, said local controller(s), said user(s) and at least one supplier that is capable of stocking and restocking items in the dispenser. The dispenser preferably comprises: (i) at least one rotatable carousel; (ii) an access hatch aligned with each carousel for accessing an interior of an item cell located within the carousel; and (iii) a motor for rotating the carousel.

### FIELD OF THE INVENTION

The invention relates to an automated item dispensing system for dispensing an item requiring minimal human intervention. The system is suited for dispensing any item or product, e.g., a biological reagent, a pharmaceutical, a consumer product, a food or beverage item, and the like.

### BACKGROUND OF THE INVENTION

Biochemical products for use in molecular biology and related research are characterised by a large number of high-value enzymes and related products, mostly sold in small volumes at high prices, that require shipment on ice and storage in a temperature controlled dispenser, with a more or less limited shelf life even under refrigeration.

A significant segment of the market for these products prefers to use on-site consignment stock, in which a supplier provides product in a dispenser located in a customer's or user's institution, but still owned by the supplier. The product is not invoiced until it is taken by a user. This allows the greatest user flexibility for their experiments. Access 24 hours a day, 7 days a week is also valued.

Manual consignment systems have many disadvantages for both supplier and user. Unreliable sign-out of products leads to difficulties in invoicing, maintaining adequate stock levels and monitoring and recalling aged products. To maintain security, access to a dispenser is via a store or other manned facility, which restricts hours of access. In general, extensive manual supervision by a travelling representative is required for the supplier to adequately maintain stocks, which leads to a high cost for the supplier to maintain service levels. Consequently, either service levels drop, resulting in poor customer experience (missing stocks, stock too old), or prices rise. Furthermore, substantial stock discrepancies (reflecting discrepancies between reported and actual usage, possibly including pilfering) arise, which either have to be accepted and paid for by the user, or borne by the suppliers. In addition, reconciling usage sheets and invoices adds a substantial administrative burden on both the suppliers and the user's purchasing/accounting department.

In summary, an on-site consignment freezer is important for the research enzyme market, but maintenance of stocks and tracking of sales is labour-intensive and expensive for both the suppliers and the user.

Current systems attempting to address the problems with on-site consignment freezers include:
1. Bar coding of products as they leave a store. This improves book-keeping, but requires manual operation of a freezer, e.g. by association with a store.
2. Adapted vending machines: machines are in the market which are basically refrigerated vending machines in which product packets are stored in spiral wire frames and delivered by rotation of the spiral. These machines have limited automation, must be visited by sales representatives to download data, and hold multiple copies of relatively few products.
3. Remote-communicating vending machines and/or related technologies as described in the following three patent applications. However, these systems are not convenient for both users and suppliers.

AU 18018/97 describes a system for dispensing medicinal products whereby a doctor communicates electronically with a central processing unit to provide product details and obtains an access code. A patient is informed of the access code and enters the access code into a dispenser, which recognises the access code, to dispense the product. This system is restrictive by requiring input and control by a doctor. Such a restriction is unduly limiting in many circumstances.

AU 684962 describes a pharmacy system for prescribing and delivering a medicament to a patient. The system includes input of patient information and prescription by a doctor, a pharmacy computer in communication with the doctor and an automatic dispenser. This system is not suited for automated tracking and maintaining of stock inventory.

U.S. Pat. No. 5,701,252 describes an invention relating to a distribution network system of automatic dispensers of products wherein each dispenser communicates with a host computer. A user communicates with a dispenser to retrieve information regarding product availability from other dispensers. A user only interacts directly with the dispenser and accesses a central controller only from the dispenser.
4. A remote-communicating freezer system is described in U.S. Pat. No. 6,393,339, which is similar to the abovementioned patents of item (3). This system, unfortunately, comprises a dispenser that does not reliably deliver products. This owes to the nature of the product (small volumes, light weight in relatively large plastic bags), frozen conditions, carousel design (a product located within a bag is slid onto and suspended from a narrow radial slot in the carousel) and complexity of precise positioning and product dispensing in a frozen environment. In use, a suspended product is removed from the carousel by a “kicker arm” that kicks the product from the slot of the carousel. This carousel encounters a problem of “mis-kicking” a product, which has lead to customer dissatisfaction, extra work for on-site coordinators and stock losses (e.g. when a mis-kicked product inappropriately falls out with a non-related purchase). In addition, the design is very restrictive of types and sizes of product packaging allowed and products have to be re-packaged to be sold via these units. Reliable product delivery is particularly important for automated or semi-automated dispensing of temperature sensitive and high value products such as enzymes.

### SUMMARY OF THE INVENTION

The invention provides automated item dispensing systems. The products of manufacture of the invention can dispense any item or product, e.g., a biological reagent, a pharmaceutical, a consumer product, a food or beverage item, and the like. In one aspect, automated item dispensing systems of the invention comprise: (a) at least one dispenser capable of dispensing an item; (b) at least one local controller in communication with a respective dispenser for controlling and monitoring the dispenser; (c) a central controller for receiving and processing electronic item orders from at least one user; (d) a communication network for providing communication between said local controller, said central controller, said at least one user and at least one supplier; wherein said dispenser comprises: (i) at least one rotatable carousel located internal to the dispenser, the carousel comprising at least one cell defined by two side walls each side wall extending from a central location of the carousel; (ii) an access hatch aligned with the or each carousel for accessing an interior of the at least one cell; and (iii) a motor for rotating the carousel.

In one aspect, it is an object of the invention to provide an alternative or improvement to the abovementioned systems and dispenser.

Typical dispensers comprise a single access hatch for retrieving a product from the dispenser and a complicated dispensing system to allow use of a single access hatch. Such dispensing systems include those described above comprising “kicker arms” and chutes to guide a product to the single access hatch.

In one aspect, the present invention uses an approach contrary to this typical approach. The present invention provides a simple dispensing mechanism, which, in one aspect, comprises multiple access hatches.

In a first aspect, the invention provides an automated item dispensing system comprising:
(a) at least one dispenser capable of dispensing an item;
(b) at least one local controller in communication with a respective dispenser for controlling and monitoring the dispenser;
(c) a central controller for receiving and processing electronic item orders from at least one user; and
(d) a communication network for providing communication between said local controller, said central controller, said at least one user and at least one supplier;
wherein said dispenser comprises:
   (i) at least one rotatable carousel located internal to the dispenser, the carousel comprising at least one cell defined by two side walls each side wall extending from a central location of the carousel;
   (ii) an access hatch aligned with the or each carousel for accessing an interior of the at least one cell; and
   (iii) a motor for rotating the carousel.

In one aspect, the system includes the step of at least one supplier delivering an item to a location of the dispenser in response to a communication received via said communication network.

In one aspect, the supplier delivers the item to a cell of said carousel. In another form, the supplier delivers the item to an operator who delivers the item to a cell of said carousel.

In one aspect, the dispenser is a temperature controlled dispenser.

The temperature controlled dispenser may be a room temperature cabinet, incubator, refrigerator or freezer.

In one aspect, the motor is located outside of the freezer. In one aspect, the motor is attached to the carousel by a shaft located central to the carousel.

In one aspect, the dispenser is suitable for dispensing biological reagents including enzymes, antibodies and kits therefor.

In one aspect, the local controller suitably performs at least one of the following functions: rotation of the carousel by controlling the motor, controlling dispensing of an item from the dispenser, monitoring an amount of an item within the dispenser, reporting to the central controller the amount of an item within the dispenser, making an activity log and temperature log of the dispenser, informing a user of availability of an item, receiving information from the central controller in relation to item delivery to the dispenser and temperature control setting of the dispenser and monitoring and controlling an internal environment of the dispenser.

The local controller may further comprise a means for reading and writing a dynamic storage device that stores information in relation to a user.

In one aspect, the dynamic storage device is a transaction card or smart card.

In one aspect, the central controller suitably performs one or more of the following functions: advising at least one user of product availability and product delivery date to the dispenser, monitoring stock levels in the dispenser, informing the supplier of product purchased by the user and requesting the supplier to stock or restock products purchased from the dispenser by a user so that the supplier may invoice the user for products purchased.

In one aspect, the local controller and the central controller respectively are computers.

In one aspect, the at least one supplier communicates with the dispenser via the central controller.

In one aspect, the communication network may be an intranet (Ethernet), the Internet or wireless means.

In a second aspect, the invention provides use of the automated item dispensing system of the first aspect to dispense an item located within a cell of the carousel.

In a third aspect, the invention provides an item dispenser for use with the automated item dispensing system comprising:
(1) an environmentally controlled cabinet;
(2) at least one rotatable carousel located within the cabinet, wherein the carousel comprises a plurality of cells defined by two side walls, each side wall extending from a central location of the carousel;
(3) an access hatch aligned with each rotatable carousel for accessing an interior of the cells;
(4) a motor for rotating the carousel; and
(5) a local controller for controlling rotation of the carousel and monitoring availability of an item located within a cell of the carousel.

In one aspect, the local controller further monitors and controls environmental conditions of the cabinet.

In one aspect, the access hatch is lockable. In one aspect, the local controller controls locking and unlocking of the access hatch.

When in use with any form of the invention, a user may check stock levels of an item located within the dispenser remotely using a communications network linked to the central and local controllers. Alternatively, or in addition, the user may check stock levels directly with the local controller by interacting with a keyboard, mouse, touch screen, voice activation or other means.

If the item is available, the user may purchase the item located in the dispenser via the local controller. The local controller (e.g. a personal computer) dispenses the oldest item of the selected item located in the dispenser and informs the supplier of the purchase for invoicing and re-stocking purposes. The local controller reads a user's smart card to confirm and record information stored on the card in relation to the user's identification and payment record.

If an item is not available, the customer can order the item via the local controller or web ordering, and central controller can inform the user directly via email, or via the local controller, when the item is anticipated to be available in the dispenser. The central or local controller can inform the user via email when the item is available in the dispenser, ie. the item has been physically located in the dispenser. The central or local controller may also inform the user of another dispenser that may have the item in stock. The central controller also informs the supplier via the communication network when an item requires restocking.

The local controller communicates with the supplier via the central controller to record information in relation to stock levels of item(s) in the dispenser, event records of when and what items were purchased by a particular user and temperature logs of the dispenser.

In use, a user may remove an item located in the cell of the carousel by purchasing the item or accepting delivery of a previously ordered item, upon which the local controller rotates the carousel via the motor to a position wherein the cell storing the item is aligned with an access hatch. The local controller unlocks the access hatch when an appropriate cell is aligned with the access hatch. Information in relation to the user, including user identification and payment details, may be confirmed by the local controller by way of reading a smart card or similar device. Instructions to order or request a product from the dispenser may be communicated with the local controller directly or remotely. In alternative embodiments, remote communication uses the internet, or, is by email via an intranet or the Internet, or, is by telephone, including wireless networks, or, any equivalents, or any combination thereof.

The invention provides automated item dispensing systems comprising: at least one multiple celled dispenser; an access hatch aligned with the dispenser for accessing an interior of the cells; a motor (or, e.g., a cell moving, or, rotating means) for moving or rotating the dispenser (e.g., moving the entire dispensor, e.g., a carosel), or one or more cells within the dispenser (e.g., independently moving one, several or all cells); and a local controller for controlling movement of the dispenser and/or the cells and monitoring availability of an item located within a cell of the dispenser. In one aspect, the automated item dispensing system further comprises an environmentally controlled device, e.g., a cabinet, e.g., a freezer or a cooling compartment.

Throughout this specification unless the context requires otherwise, the word “comprise”, and variations such as “comprises” or “comprising”, will be understood to imply the inclusion of the stated integers or group of integers or steps but not the exclusion of any other integer or group of integers.

The details of one or more embodiments of the invention are set forth in the accompanying drawings and the description below. Other features, objects, and advantages of the invention will be apparent from the description and drawings, and from the claims.

All publications, patents, patent applications cited herein are hereby expressly incorporated by reference for all purposes.

### DESCRIPTION OF THE DRAWINGS

In order that the invention may be readily understood and put into practical effect, preferred embodiments will now be described by way of example with reference to the accompanying drawings wherein like reference numerals refer to like parts and wherein:

FIG. 1 shows components of the automated product dispenser system linked via a communications network;

FIG. 2 shows basic interactions between a user and components of the automated product dispenser system;

FIG. 3 shows communication links between multiple dispensers and multiple users;

FIG. 4 is a flow chart of steps a user may take when using the automated product dispenser system;

FIG. 5 shows information and item (e.g. products, invoices) flow between components of the automated product dispenser system;

FIG. 6 shows a plan view of a dispenser showing product carousel and access hatch;

FIG. 7 shows a side view of a dispenser as shown in FIG. 6 showing a preferred embodiment of multiple carousels with one access hatch per carousel;

FIG. 8 shows an isometric view of a two tiered carousel that may be used with a dispenser shown in FIGS. 6 and 7;

FIG. 9A shows a side sectional view of a form of an item loading and unloading mechanism whereby the item is pushed out of a cell;

FIG. 9B shows the item loading and unloading mechanism of FIG. 9A after the item has been pushed from the cell;

FIG. 10A shows a side sectional view of a form of an item loading and unloading mechanism whereby the item is pulled out of a cell;

FIG. 10B shows the item loading and unloading mechanism of FIG. 10A after the item has been pulled from the cell;

FIG. 11A shows a side sectional view of a form of an item loading and unloading mechanism whereby the item is pulled by rollers out from a cell;

FIG. 11B shows the item loading and unloading mechanism of FIG. 11A with rollers engaging the item; and

FIG. 11C shows the item loading and unloading mechanism of FIGS. 11A and 11B after the item has been rolled out from the cell.

### DETAILED DESCRIPTION OF THE INVENTION

The present invention provides an automated item delivery system that is capable of accurately dispensing a product 24 hours a day, 7 days a week.

The automated item delivery systems of the invention address the needs of scientific researchers, especially molecular biologists, who often produce results in a matter of hours. This fast paced field requires reagents to be available whenever needed by a researcher. The automated item delivery systems of the invention can be used to supply materials to any group for any purpose, e.g., to engineers, consumers and the like.

In one aspect, the invention provides a cost-effective method of maintaining a consignment freezer that was automated, including an automated item delivery system that was automated in various aspects; including as many aspects of the dispenser as possible In one aspect, minimal human intervention is required for product loading, delivery, invoicing stock control, monitoring stock and stock adjustment In one aspect, a product is accurately and reliably dispensed from the dispenser. This is important when dispensing an expensive temperature sensitive product.

It will be appreciated that an “item” also refers to a “product”, which includes any suitable item for dispensing, such as a biological reagent, medicament, pharmaceutical, food product or any other product that may be located within an item cell for dispensing. In one aspect, an item is an item of relative high value requiring delivery control and accurate tracking. Such items include pharmaceuticals and biological reagents. A biological reagent includes enzymes, blood products, cells (including sperm), antibodies, other proteins, nucleic acids and the like. Such biological reagents are commonly known in the art and may be commercially produced by companies such as New England Biolabs and Cell Signaling Technology.

In one aspect, e-mail is selected as a communications means because it is easy to create, interpret, and can be continuously running (via an ethernet network) without requiring an Internet server which may be subject to hacker attack. Also, a rapid response is possible by frequent automatic checking of e-mails.

The invention also provides a dispenser capable of dispensing temperature sensitive products, including biological reagents such as enzymes as described above.

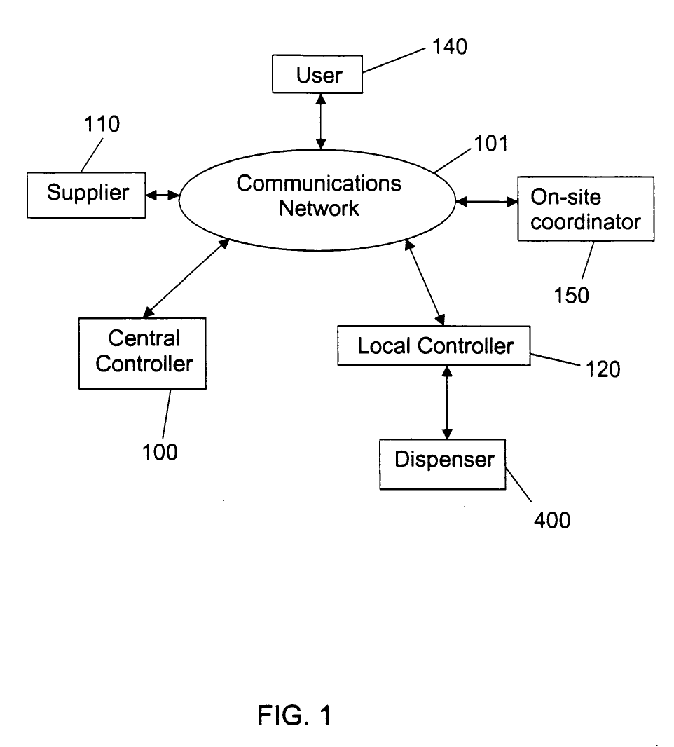

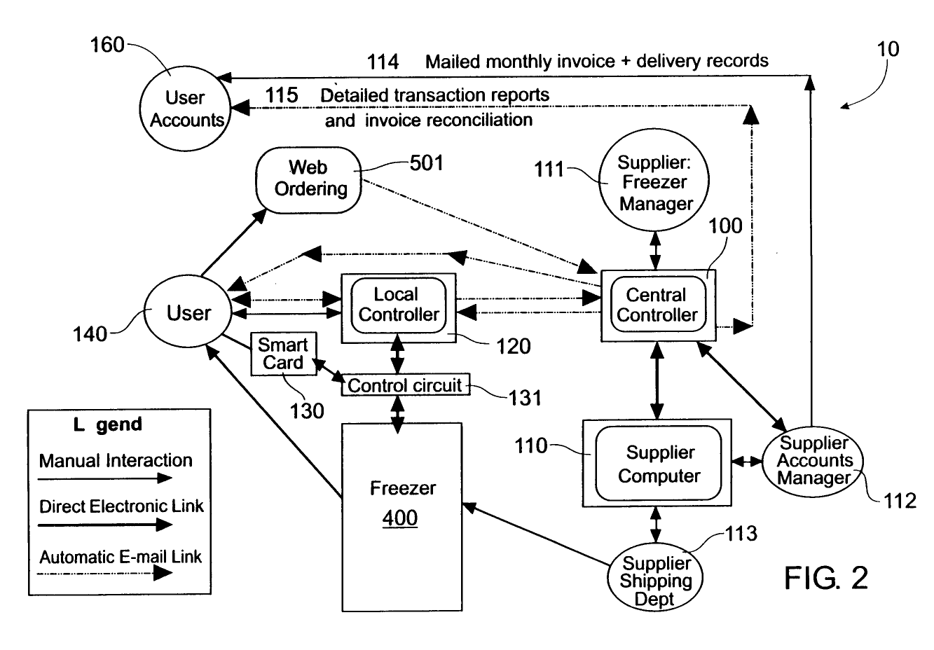

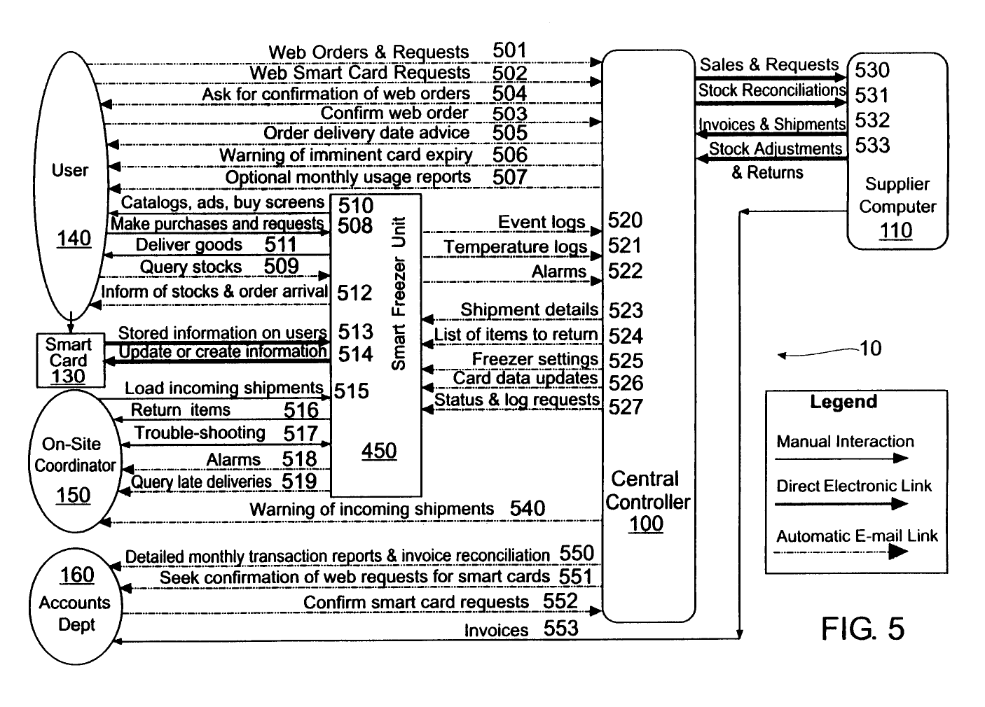

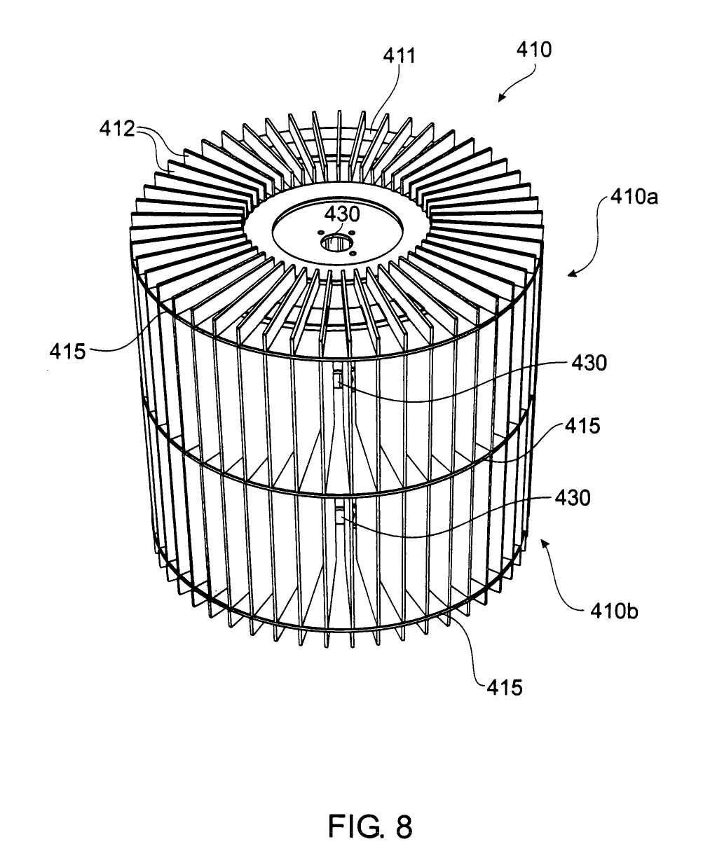

The automated item dispensing system 10 in alternative embodiments comprises components as shown in FIGS. 1 to 11. Although the figures show interaction of a user with the automated item dispensing system 10, it is understood that the user interacts with the system and does not form part of the system per se. In one aspect, a dispenser 400 is shown as a freezer. However, it will be appreciated that the dispenser may be, for example, a refrigerator, incubator or room temperature cabinet. As shown in FIG. 5, a “smart freezer unit” (item 450) comprises local controller 120, control circuit 131 and freezer 400 as shown in FIG. 2.

A user 140 includes a customer or buyer of a product stored in dispenser 400 and may also be an on-site coordinator (also referred to as an operator or on-site manager) 150. Supplier 110 includes, for example, a supplier of a product that is located in dispenser 400. Such a supplier may include a commercial company that produces the product, for example, New England Biolabs and Cell Signaling Technology.

The automated item dispensing system in one aspect comprises the following major components.

Dispenser: A standard domestic freezer can be modified by installing sensors and effectors for monitoring dispenser status and enable product loading and product dispensing whereby a computer can sense where all products are located within the dispenser. As discussed below, a carousel 410 located within dispenser 400 is used to store products in identifiable locations within a product cell 411. A bar code reader may be used for simplified and robust incoming product identification and a smart card reader for user identification. Although the dispenser is exemplified as comprising a freezer, it will be appreciated that any other suitable cabinet-type housings may also be used, for example a cabinet at room temperature, a refrigerated cabinet or an incubator, e.g., including a heating element or a humidifier. Also, although controlling temperature of the dispenser is exemplified herein, it will be appreciated that other environmental conditions may be controlled, for example, humidity, light, gas content and the like. In one aspect, the cabinet-type housing is substantially sealed from the external environment.

Local controller: local controller 120 is exemplified as a personal computer (PC) that is connected to dispenser 400. It will be appreciated that the local controller can be any suitable computer (or equivalent) known in the art that is capable of processing information and locally or remotely storing information. The local controller may comprise additional features that are common with PC or suitable computer, such as a touch screen for “point-and-click’ type interface, CD drive, floppy disk drive, keyboard, mouse controller, monitor and the like. Local controller 120 communicates with the dispenser 400 via a customised circuit board 131. Local controller 120 provides a user interface to enable product selection and/or ordering; controls and remembers which products are delivered and where incoming products are located; accepts, validates and interprets incoming e-mails; and constructs and sends outgoing e-mails. Local controller 120 communicates with central controller 100, which for example may be referred to as a “master computer”, for receiving catalogue changes, software upgrades, special promotions for local display, listing of incoming products and products being recalled, and general system settings such as temperature and alarm set is points; sending transaction and event records, stock levels, temperature logs and status reports. Local controller 120 also communicates with a user 140, for responding to stock level queries, advising on-site coordinators and/or suppliers of alarm conditions, informing user 140 when products they have ordered have arrived.

Control circuit: Control circuit 131 is shown as a customised circuit board linked to the local controller 120. Control circuit 131 handles low-level events, including for example reading sensors and controlling outputs such as LEDs, motors and solenoids, and controlling the smart card reader/writer. The control circuit 131 communicates with the local controller 120, which provides a user interface and high-level interpretation, supervision and control.

Smart Cards: users 140 and on-site coordinators 150 are issued with uniquely identified (eg numbered) smart cards 130, which store identification information, access permissions (such as on-site coordinator versus normal user) and optional budget limitations and expiry dates. Users can only purchase items from the dispenser by inserting their smart card and entering a valid password, which identifies a specific user 140 (in one aspect, a maximum of 10 users are allowed per card). On-site coordinators can in addition load incoming stock, re-load items purchased by mistake, remove stock for return to the supplier, alter user card data locally, and access detailed diagnostic and historical information (all under direction of local controller 120). The complete card database is stored in central controller 100 and can be modified thereby (e.g. to re-activate deactivated cards, deactivate lost cards, add users 140, reset forgotten passwords or change spending limits), upon which those changes are e-mailed to a user's smart dispenser or e-dispenser 450, which writes the changes to their card the next time it is used. Although one aspect of the invention includes use of smart cards, it will be appreciated that any suitable means whereby a user may be identified and personal data is stored may be used. For example, a portable storage device capable of being read and written by the local controller either in direct contact such as a smart card or in the absence of direct contact, such as a device incorporating Bluetooth-type of technology.

Central controller: Central controller 100 processes incoming e-mails, interprets encoded events and sends e-mails to a local controller 120. Over 120 distinct events may be supported, including stock items sold, items ordered or requested, incoming items loaded, items returned, problems and alarms.

A central program of central controller 100 interprets information of an e-mail and communicates with a sales program of supplier computer 110, thereby informing supplier computer 10 what has been purchased, ordered, stocked or returned, and receiving from it information regarding items sent or required back (for example stock level adjustments or return of aged stock). These functions could be combined into one program, but a dedicated central program in central controller 100 provides maximum flexibility, allowing different personnel to monitor the dispenser itself versus invoicing and stock control, and allowing integration with whatever invoicing and stock control program the supplier uses. The central program also accepts and interprets web-based stock requests and orders via the smart freezer unit 450 (i.e. e-dispenser) and communicates directly and automatically with a user 140 by e-mail to confirm or query orders.

In one aspect, most of the above process is fully automated. In one aspect, it is fully automated. In one aspect, human inputs include: a user 140 interacting with the smart freezer unit 450 to select and purchase products; an on-site coordinator 150 to load or stock incoming products, ship back aged products and solve minor problems; and supplier administrative staff: supplier freezer manager 111, supplier accounts manager 112, suppler shipping department staff 113 to print invoices (from automatically generated orders) and ship the products to desired locations.

Because of the level of computerization of this system, detailed transaction reports can be issued to accounting departments and users along with their respective monthly statements, by mail or automatically via e-mail, which informs them exactly who bought what products and at exactly what date and time.

FIG. 1 shows components of the automated product dispenser connected via communications network 101. Communications network 101 may be the Internet, an intranet, a wireless means for example wireless telecommunications, any other known communications network or a combination thereof. A user 140 accesses the communications network 101 from a computer at their location, such as a PC. User 140 is capable of communicating with central controller 100, local controller 120 that controls and monitors dispenser 400, supplier 110 and on-site coordinator 150. In one aspect, user 140 communicates using email. Each of the components and interactions there between will be discussed in more detail hereinafter.

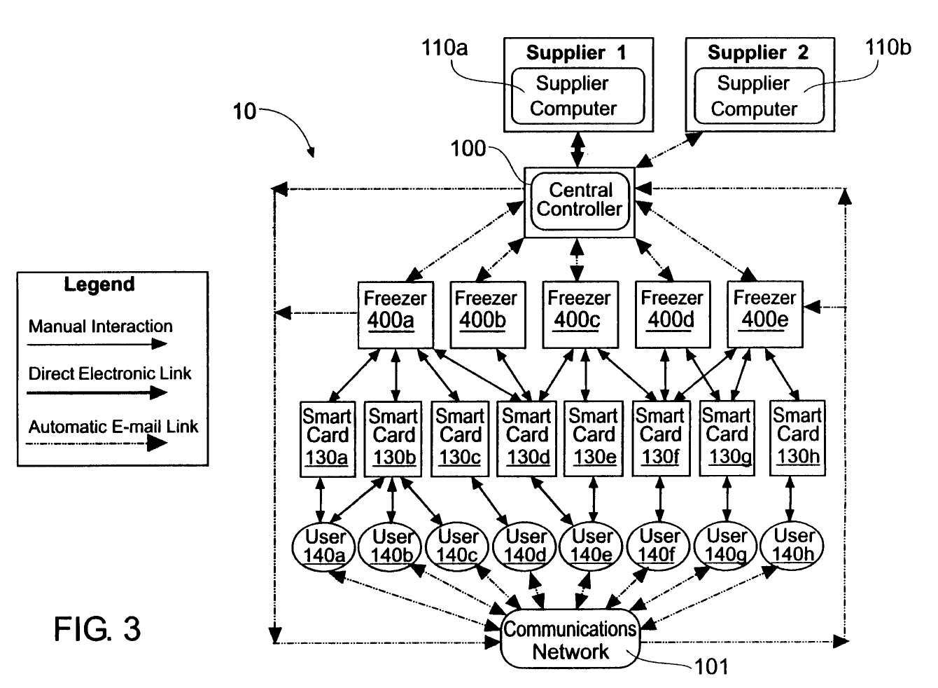

FIG. 2 shows human-machine and machine-machine interactions and FIG. 3 shows communication between the components of the automated item dispensing system 10. User 140 interacts with local controller 120 through physical interaction, for example keyboard entry and monitor, touch screen, or remotely via email. Local controller 120 can provide user 140 with product availability, price and product information. User 140 is also capable of purchasing a product through direct physical interaction with local controller 120. User 140 is further capable of interacting with local controller 120 via smart card 130 that provides local controller 120 with user information. User 140 is also capable of ordering, by web ordering 501, a product from freezer 400 by contacting central controller 100.

Local controller 120 can communicate with central controller 100 and user 140 via email. Local controller 120 is directly linked electronically with control circuit 131 that controls freezer 400 and reads and writes to smart card 130. Local controller 120 and control circuit 131 monitor and control aspects of freezer 400 function including product inventory, freezer temperature and dispensing of product.

As shown in FIG. 2, central controller 100 communicates via electronic links with: user 140, local controller 120, user accounts personnel 160 and supplier computer 110. Central controller 100 is shown electronically linked to user accounts 160 and sending detailed transaction reports and invoice reconciliation 115. Central controller 100 communicates physically with supplier personnel, for example supplier freezer manager 111, supplier accounts manager 112 and supplier shipping department 113.

The supplier dispenser manager 111 can manually input and retrieve information from central controller 100 in relation to a product dispensed by freezer 400. Supplier personnel in shipping department 113 can ship products, for example by courier, for stocking by on-site coordinator 150 or manually stock freezer 400 with product. Personnel of shipping department 113 can also input information into supplier computer 110 in relation to product invoicing and stock.

An accounts manager 112 of the supplier can input and retrieve from supplier computer 110 information in relation to user invoice and dispenser stock. The supplier accounts manager 112 may provide an invoice and delivery records 114 to user or user accounts 160. An invoice may also be provided by a printer connected to local controller 120 or e-mailed automatically if Accounts Department 160 accepts such.

FIG. 3 shows communication between elements within an entire automated item dispensing system 10, linking multiple freezers 400a-400e and multiple users 140a-140h. A supplier computer communicates with central controller 100 either by direct electronic link 110a or via email 110b, which may also be a same supplier computer. Central controller 100 communicates with freezers 400 (via local controller 120 shown in FIG. 2) and user 140 via email using the communications network (e.g. the Internet) 101. Freezer 400 communicates with smart card 130, which can be used with multiple freezers 400 that may be located at different locations and/or stock different products. Respective smart cards 130a-130h are under control of user 140; there may be multiple smart cards 130a-130h per user 140 and/or multiple users 140a-140h per smart card 130.

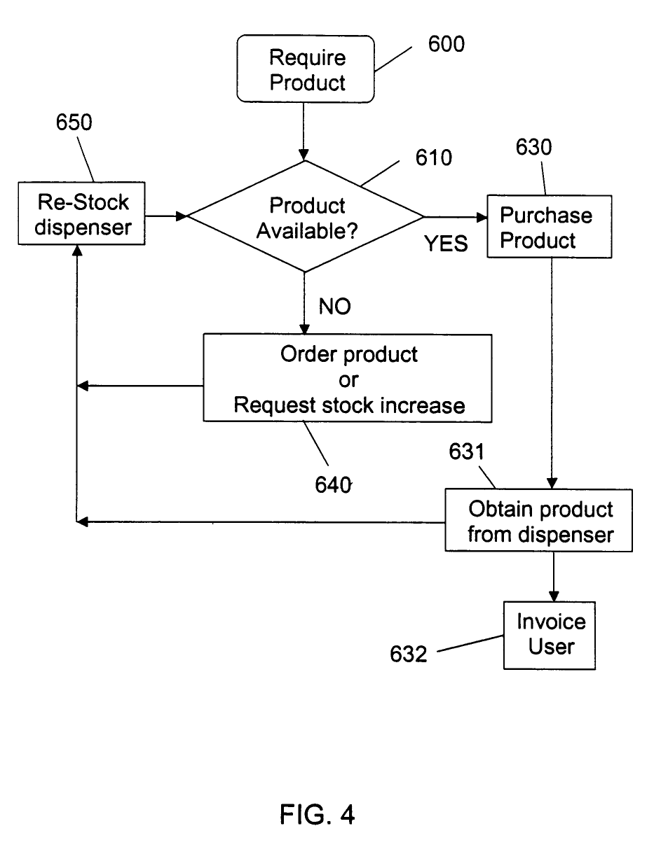

FIG. 4 shows steps that can be taken by a user when enquiring or making a purchase from a smart freezer unit 450. A user requiring a product 600 can check stock level or availability of the product 610 by communicating with the central or local controller as described herein. If the product is available, the user can purchase the product 630 by emailing the central controller or directly by contacting the local controller physically in person. The user then obtains the product from the dispenser 631 by instructing the local controller to dispense the product. An invoice 632 may be provided by the local controller and/or information in relation to the transaction can be sent to the central controller whereby the supplier may access the central controller and invoice the user. Upon removal of the product, the purchased item may be re-stocked in the dispenser 650. The local controller communicates with the supplier via the central controller thereby informing the supplier to re-stock the purchased item in the dispenser.

If the product is not available, the user may instruct the central or local controller to request the product 640 to be delivered to the dispenser or the local controller may inform the user of another dispenser that has the product in stock. The local controller contacts the central controller to request re-stocking of the dispenser with product 650.

FIG. 5 is a diagram of information flow between components of the system 10: user 140, smart card 130, on-site coordinator 150, accounts department 160, smart freezer unit 450 (comprising local controller 120, control circuit 131 and dispenser 400 shown in FIG. 2), central controller 100 and supplier computer 110.

FIG. 5 shows exchange of information via an automatic email link between user 140 and central controller 100 and smart freezer unit 450. User 140 may manually carry a smart card 130. User 140 is shown sending central controller 100 a web order and request 501, web smart card request 502 and confirmation of a web order 503. Central controller 100 is shown sending user 140 a request to confirm a web order 504, providing order delivery date advice 505, warning of imminent card expiry 506 and optional monthly usage report 507.

FIG. 5 also shows exchange of information between user 140 and a smart freezer unit 450. User 140 is shown manually purchasing a product 508 from smart freezer unit 450 and querying stock via an email link 509. Smart freezer unit 450 is shown displaying to the user 140 product information 510, for example catalogue and advertisement via a computer monitor, dispensing a product 511 to user 140 and communicating with user 140 via email 512 to inform the user of available stock and when an ordered product has been stocked in smart freezer unit 450.

Smart card 130 is shown communicating with smart freezer unit 450 via a direct electronic link 513, for example a smart card reader. Smart card 130 provides smart freezer unit 450 with stored information in relation to a user. Smart freezer unit 450 via direct electronic link 514 updates or creates information on smart card 130.

On-site coordinator, also referred to as an operator, 150 also interacts with smart freezer unit 450 by manually loading 515 new product into smart freezer unit 450 and removing and returning product 516 (eg. out dated product) from the smart freezer unit 450 and returning the removed product(s) to the supplier. Trouble-shooting information 517 is also exchanged between on-site coordinator 150 and smart freezer unit 450. Smart freezer unit 450 can alert on-site coordinator 150 of problems, for example incorrect freezer temperature, via an alarm. On-site coordinator 150 is shown receiving an alarm via an email link 518. The smart freezer unit 450 can also contact on-site coordinator 150 via email to query a late delivery 519.

Smart freezer unit 450 also communicates with central controller 100 electronically via an email link. The smart freezer unit 450 provides central controller 100 event logs 520, temperature logs 521 and alarms 522. Central controller 100 provides smart freezer unit 450 shipment details 523, list of return items 524, freezer settings 525, card data updates 526 and status and log requests 527.

Central controller 100 is shown in FIG. 5 as communicating with supplier computer 110 via a direct electronic link. Central controller 100 provides supplier computer 110 with sales and request information 530, stock reconciliation 531; and supplier computer 110 can inform central controller 100 of invoice and shipment information 532 and stock adjustments and returns 533.

Central controller 100 also communicates with on-site coordinator 150 via the Internet and/or email warning of incoming shipments 540. Central controller 100 also communicates with accounts department 160 providing transaction reports and invoice reconciliation reports (eg detailed monthly reports) 550 and confirmation of web requests for smart cards 551. Accounts department 160 can confirm smart card requests 552 with central controller 100 via email. Supplier computer 110 can generate an invoice for products purchased by user 140 and the invoice can be posted 553 to accounts department 160.

The various communication links shown in the figures are exemplary examples. However, it will be appreciated by a skilled person in the art that other communication links may also be used. For example, where a direct electronic link is shown, such a link could be replaced by a different type of communication link, including the Internet and wireless communication. Also, where Internet connections are referred to, such a connection could also be an intranet connection.

Item Dispenser

A problem confronting known dispensers is reliable product loading and dispensing, which may allow flexibility in product packaging and size. Difficulties encountered in implementing a known dispenser that requires products to be “kicked” or pushed into a chute (including overcoming mis-kicks due to alignment problems of a product and dispensing into the chute, effects of ice, jamming, bent packaging and metal distortion due to temperature changes) led to removal of all motors and solenoids from the dispenser compartment and implementation of a dispenser in which a user removes the product therefrom (only the correct product being presented).

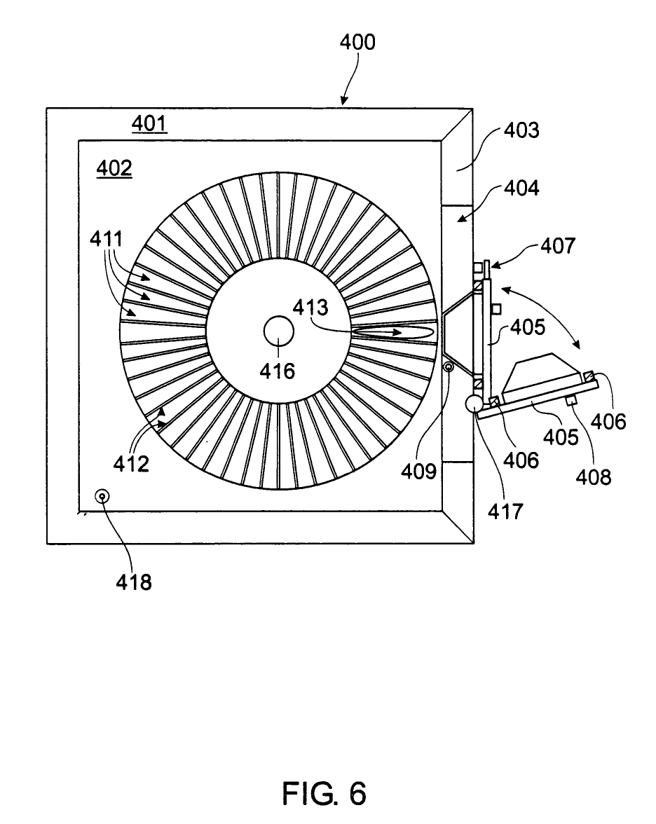

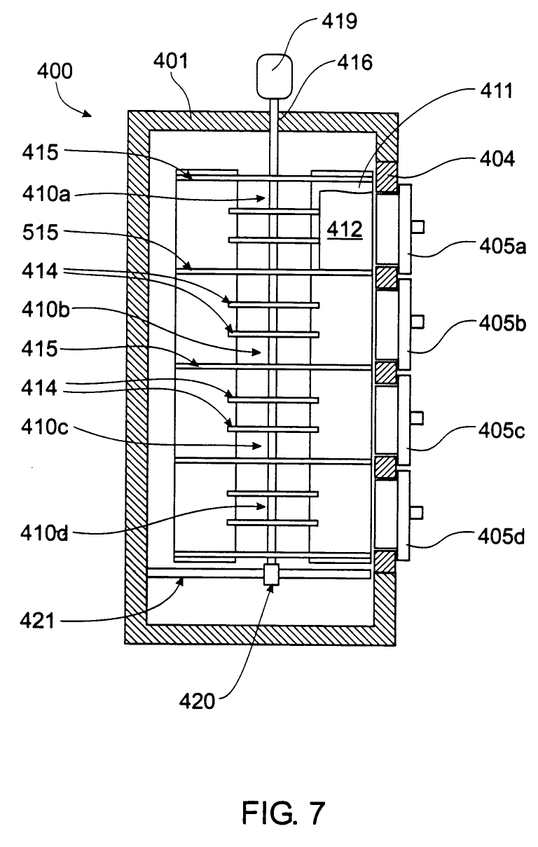

In an embodiment shown in FIGS. 6 and 7, a dispenser 400 (which in one aspect comprises a freezer, a cooling agent or a heater) enclosed by walls 401 and main dispenser door 403. Within the dispenser is a multi-layer carousel 410 shown comprising four carousels 410a-410d stacked on top of each other.

Each carousel 410a-410d is aligned with a respective access hatch 405a-405d, which permits access to a single item cell 411.

Access hatch 405 is a small door within a main dispenser door 403 that is aligned with a respective carousel. Accordingly, the term access hatch 405 is used herein to avoid confusion with a main dispenser door 403. To load a product, local controller 120 determines a location of a slot or item cell 411, rotates carousel 410 to a correct position and locks carousel 410 in place, then unlocks an appropriate access hatch 405, which allows a user to access to a proper item cell 411 (and only a proper product cell) that contains a selected product 413. Hatch 405 closes automatically upon release by the user and hatch 405 is relocked. This design enables precise control over product loading and dispensing, with minimal loss of cold air or entry of warm humid air into dispenser chamber 402. Optionally, one or more sensors 409 may be included to detect product insertion and/or removal. Such sensor(s) for example may be located adjacent to or within hatch 405. In one form, the sensor is a beam (for example light, such as a laser) that crosses a gap on the inside of an aperture into which the hatch 405 occupies when the hatch 405 is closed.

Because a product 413 is located in a product cell 411, a product 413 of various size and shape can be accommodated easily in a same or different dispenser. For example, 200 normal package sizes sold by Genesearch Pty Ltd can be loaded into a standard Fisher & Paykel vertical freezer (50 slots×4 carousels). Any combination of products can be stored (for example, one of each or multiples of popular products). Larger products such as kits or larger volume tubes can be accommodated by using a larger product cell 411 and access hatch 405. In one embodiment, the carousel may have removable side walls so that one or more side walls may be removed to create a larger product cell. The size of the product cell may be determined by a person skilled in the art, such as an operator, and an appropriate number of side walls removed.

A number of designs for loading and dispensing a product from dispenser 400 are possible, including the following examples.

Direct access: An exemplary dispenser 400 of the invention is shown in FIGS. 6 and 7. A hatch 405 is hinged with a spring hinge 417 (or separate spring) and opened by a user, who reaches into dispenser 400 and removes a product 413 from a selected product cell 411. Loading product 413 is by a reverse operation. This method has the virtue of simplicity and robustness. In addition, carousel 410 can be constructed simply with interlocking sheets, giving a rigid and robust construction.

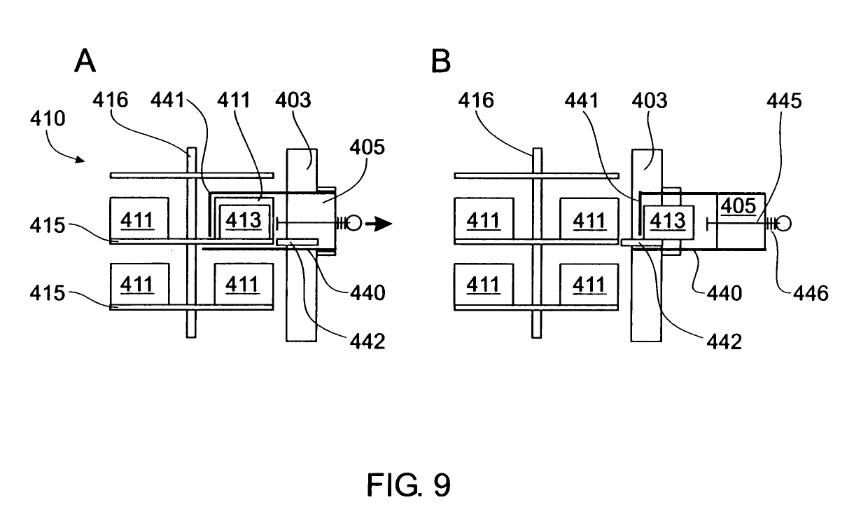

Auto push: In this embodiment, shown as a sectional side view in FIGS. 9A and 9B, hatch 405 also comprises slideable bottom support 440, shown as a sliding tray or floor extending below support disk 415 of carousel 410. A pushing arm 441 extends over item cell 411 410 and behind item 413 as shown in FIG. 9B. The pushing arm 441 is shown comprising an item inserting arm 445 with an optional spring 446 that assists with pushing the item 413 into the item cell 411 when inserting or loading the item 413 into the item cell 411 (for example when stocking an item). In use, a user pulls the hatch 405, which comprises the bottom support 440 and pushing arm 441, away from the main door 403 (movement shown by dark arrow). In doing so, the item 413 is pushed from a rear location out from the item cell 411 through hatch 405. The item 413 may be supported by a fixed bottom support 442, whereby the user can access and remove the item therefrom.

Loading a product is via a reverse operation to removal: an on-site coordinator (or supplier personnel or other suitable person) pulls out the hatch 405 from a location wherein the item cell 411 is not occupied by an item 413 (chosen by local controller 120), inserts an item 413 between item inserting arm 445 and pushing arm 441 and pushes the hatch 405 into the item cell 411, thereby inserting item 413 into the item cell 411. This embodiment has an advantage that the user does not have to reach into the dispenser 400 to remove the item 413 and merely requires opening hatch 405 to remove the item. In this embodiment, multiple carousels 410 cannot share item cell side walls 412 (as the slideable bottom surface and push arm interpenetrate its position) and a modified design is required for inserting and removing the product as shown.

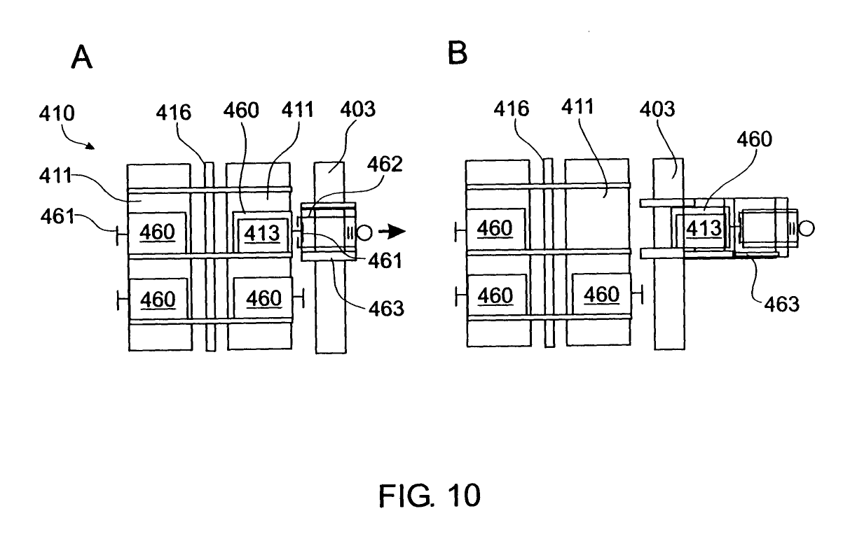

Auto pull: In this embodiment, shown in FIGS. 10A and 10B, an item 413 is located in a removable item container 460, for example an open-top holder or a uniformly-manufactured product holder (in one aspect, made of moulded plastic), which is located in an item cell 411. A front part of the removable item container 460 has a member 461 that is adapted to engage a puller 462 located at an inside part of the hatch 405. The member 461 is shown as a pin or bar that engages the puller 462 mechanically, however, the member 461 may engage the puller 462 by other means, for example by a magnetic interaction therebetween. The hatch 405 is pulled open as shown in FIG. 10B and in doing so a slideably extending support 463 extends outward from the main door 403. The removable item container 460 is supported by the extending support 463 when it is pulled from the cell 411.

This embodiment has an advantage that the hatch 405 does not have to interpenetrate the carousel, and product movement and placement is controlled by a uniformly-manufactured product holder, thus avoiding possible problems caused by variations in product packaging, irregular shape of a plastic bag, etc.

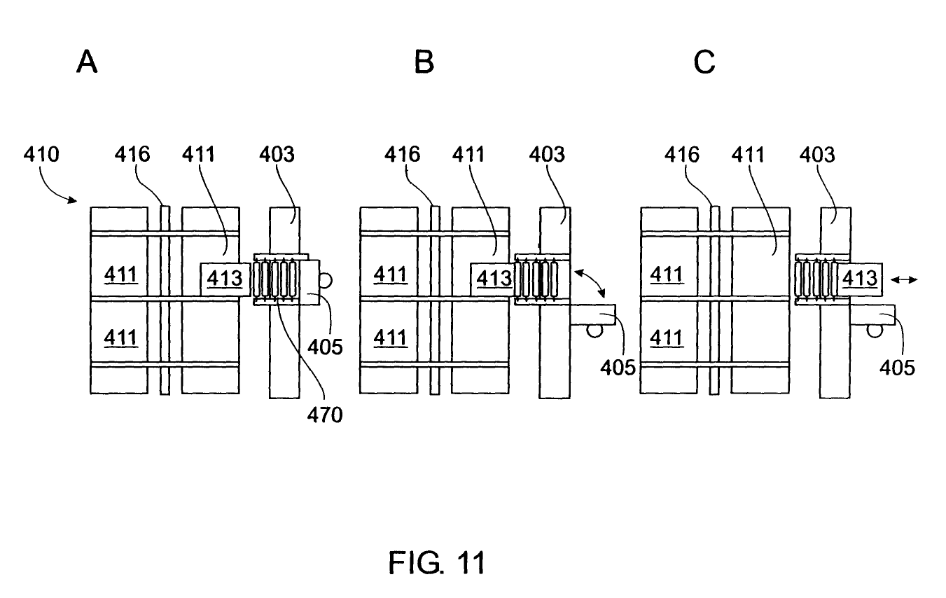

Auto rollers: In this embodiment, shown in FIGS. 11A-11C, hatch 405 comprises a horizontal hinge, movement is shown by double-headed arrows. However, hatch 405 may in an alternative embodiment comprise a vertical hinge similar to other embodiments shown herein. A set of motorised rollers 470 located in the main door 403 engages an item 413, that is located within a product pack. FIGS. 11B and 11C show the rollers 470 pulling the item 413, that is within a product pack, out from an item cell 411 to thereby remove the item 413 from the cell 411. To load an item into a cell 411, the process is reversed so that the item 413 is placed adjacent rollers 470 and rollers 470 engage the item 413 to thereby pull the item 413 into a cell 411. This embodiment has an advantage of moving the item in and out of a cell 411 automatically and requires only a simple hatch 405.

For clarity, FIGS. 9-11 each show only a single embodiment, ie auto-push mechanism, auto-pull mechanism and auto-rollers mechanism, for the top carousel without surrounding components, eg freezer walls. However, it will be understood that a same type of mechanism may be located adjacent each carousel. Alternatively, any other suitable hatch mechanism may be used for accessing a cell of a carousel, for example any of the hatch mechanisms described herein. Accordingly, the dispenser may comprise a same type of hatch for accessing cells of each carousel or the dispenser may comprise any combination of hatch mechanisms.

Modification of a Vertical Domestic Freezer (Dispenser)

Freezer compartment carousel. A dispenser 400 comprises a circular carousel 410 that is divided into item cells 411, also referred to herein as product cells, defined by two side walls 412, each extending radially from a central location of the carousel and extending through all carousels 410a-410d. However, in one embodiment, respective side walls 412 may not extend beyond a support disk 415 located between adjacent carousels. Above and below the item cell 411 are support disks 415 and stop disks or rings 414 are located at a rear of the item cell 411, which is opposite an end through which product is loaded and removed. Cells 411 can be any size appropriate to hold a desired product and number of item cells per carousel may be determined based on requirements of the users. For example, a suitable arrangement for biochemical products includes 50 item cells 411 per carousel 410 and four carousels 410a-410d per dispenser 400, which provides a total of 200 item cells 411 as shown in FIGS. 6 to 8. Stop disks 414 as shown in FIG. 7 prevent products from being inserted or moving too far inside item cell 411 while retaining good airflow throughout the cabinet and around the products. Airflow may be important to maintain a temperature sensitive item at an appropriate temperature.

Although four carousels are shown, it will be appreciated that the number of carousels may range from a single carousel to any suitable number, including more than four, for example five, six, 10 and even more. Also a size of each carousel, and number of item cells, may be determined by a person skilled in the art. Accordingly, if there is a large number of items to be dispensed, for example when a large number of users have access to the dispenser, the carousel may be larger than when fewer users have access to the dispenser so that more cells (and hence more product) may be located within each carousel. Likewise, the number of carousels may additionally or alternatively be increased to increase a volume of product that may be stored within the dispenser.

The carousels are mounted on a shaft 416 that extends through apertures 430 in respective support disks 415 and a similar aperture through the top of dispenser 400. Shaft 416 is rotatably secured to a support 421 of dispenser 400 by bearing 420. Located inside the dispenser compartment or chamber 402 are the carousel 410 and a temperature sensor 418, and optionally the carousel position locking mechanism (not shown). It will be appreciated by a skilled person that dispenser 400 could alternatively be a refrigerator, incubator or any other useful cabinet, including a room temperature cabinet.

Top: A top part of dispenser 400 comprises an electronically-controlled motor 419, such as a computer-controlled motor, that moves carousel 410; carousel position lock (if not located within the cabinet); carousel position and movement sensor, including “home position” sensor; custom-built circuit for communicating with dispenser sensors, operating motors, locks, solenoids etc, and communicating with the computer; computer which communicates with the circuit, interacts with users and processes e-mails; backup power; alarms; bar code reader; smart card reader/writer. Other suitable arrangements of the motor 419, shaft 416 and bearing 420 are contemplated. For example, although the motor 419 can be located above the dispenser 400, the motor 419 may also be located at other suitable positions such as below and at the side thereof. Also, although the motor can be located external to the dispenser 400, the motor 419 could be located within the dispenser. Further, gearing, chains, cables and other components typically associated with motors and drivers, in particular rotational drivers, may be included as necessary.

Dispenser Door: A standard insulated panel or door insert 404 is located within a main door 403, and the door insert 404 comprises a hatch 405 (one hatch per carousel) having a handle 408 to enable opening and closing of the hatch 405 for loading and dispensing a product 413 within an item cell 411. Each hatch 405 is lockable and preferably comprises sensors 409 to detect opening and closing of the hatch 405 and product 413 loading and dispensing. The hatch may be lockable by an electronic locking mechanism, for example a locking mechanism controlled by the local controller and/or by a mechanical mechanism, for example a lockable latch. Each hatch 405 auto-closes via a spring 417 or other suitable closing mechanism and is held tightly shut against seals 406 (which may be made of rubber, silicon, neoprene or other material known in the art) via a securing means 407, which may comprise magnets, latch, lock or other suitable means. An aperture in dispenser door 403 can receive a standard door insert 404. Alternatively, an entire door can be replaced by a new door constructed with hatches 405 as described above.

Dispenser Electronics: Owing to the sensitive nature of the products, dispenser electronics are modified to place compressor cycles and defrosts under control by local controller 120, whose parameters can be changed remotely via central controller 100.

Smart cards: A smart card 130 can store access privileges (such as user, coordinator, supplier etc), card number, user name, creation date, modification date, expiry date if any, spending limit if any and spending refresh interval, and total spending to date; a list of user names, passwords, total spent, expiry dates if any and spending limits if any; and tax code. User identification to a smart dispenser or e-dispenser 450 is achieved by insertion of smart card 130 into a smart card reader located as part of control circuit 131 and keying in a user password.

Local Controller (Dispenser Computer) Functions

User interface: FIGS. 2 and 5 show interaction between a user 140 and local controller 120. A graphical user interface (optionally via touch-screen) provides a user 140 with general information, special information (such as advertisements and special offers), and access to ordering functions, for example, product lists, prices, available stock, purchases, ordering of items not in stock, stock requests, item return (requires on-site coordinator). A bar code reader allows reliable electronic identification of incoming stock. A smart card reader/writer that as part of control circuit 131 identifies a user 140 and their spending limits if any, and modifies the smart card 130 according to user 140 spending and any data changes transmitted from central controller 100.

On-site Coordinator functions. Functions of an on-site coordinator 150 includes, for example, product loading; emergency empty and replacement; product return to supplier due to age or stock level adjustments; trouble-shooting, testing and diagnostics.

User (customer) internet functions: As shown in FIGS. 1 to 5, a user 140 can e-mail the dispenser 400 via the communications network 101, for example via the Internet, for current stock holdings and order arrival. Local controller 120 automatically e-mails a user 140 when ordered items or stock requests arrive. Local controller 120 automatically e-mails on-site coordinator 150 and dispenser owner upon alarm conditions, for example if temperature of dispenser 400 rises above a predetermined limit. A user 140 can also “web order” 501 to request stock or place orders via the communications network 101, for example the Internet. A web order 501 is interpreted by a Central program of central controller 100 and if valid, web order 501 is communicated to the appropriate smart dispenser (ie. e-dispenser) 450.

Supplier e-mail functions: A supplier, for example a product supplier, can e-mail information using supplier computer 110 to local controller 120 via central controller 100. Information may include general settings (e.g. passwords, temperature set points); product/price lists; incoming shipments; products to return. Local controller 120 e-mails to the supplier via supplier computer 110 the events log, temperature logs, and dispenser status.

Central Controller Computer Functions Include:

Central controller 100 is a computer capable of processing e-mails from local controller 120 and web orders 501; communicates with invoicing/stock control/accounting programs 110 to record product usage and receive information on what is being charged, shipped to or returned from the dispensers; central database facilities; automatic reminders to customers regarding impending card expiry; monthly transaction reports to customers for accounts reconciliation. Central controller 100 also communicates with standard accounting department 160 and stock control.

Supplier Computer Functions

Supplier computer 110, processes sales and orders communicated via central controller 100, generates invoices and statements for user accounts 160, and communicates with shipping department 113 for sending and returning stock from freezers 400. This can be the supplier's existing system for invoicing and stock control modified as and if required for communicating with central controller 100.

It is understood that the invention described in detail herein is susceptible to modification and variation, such that embodiments other than those described herein are contemplated which nevertheless falls within the broad scope of the invention.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

The disclosure of each patent and scientific document, computer program and algorithm referred to in this specification is incorporated by reference in its entirety.

1. An automated item dispensing system comprising:
(a) at least one dispenser capable of dispensing an item;
(b) at least one local controller in communication with a respective dispenser for controlling and monitoring the dispenser;
(c) a central controller for receiving and processing electronic item orders from at least one user;
(d) a communication network for providing communication between said local controller, said central controller, said at least one user and at least one supplier;
wherein said dispenser comprises:
(i) at least one rotatable carousel located internal to the dispenser, the carousel comprising at least one cell defined by two side walls each side wall extending from a central location of the carousel;
(ii) an access hatch aligned with the or each carousel for accessing an interior of the at least one cell; and
(iii) a motor for rotating the carousel.

2. The automated item dispensing system of claim 1 wherein said system includes the step of at least one supplier delivering an item to a location of the dispenser in response to a communication received via said communication network.

3. The automated item dispensing system of claim 2 wherein the at least one supplier delivers the item to a cell of said carousel.

4. The automated item dispensing system of claim 2 wherein the at least one supplier delivers the item to an operator who delivers the item to a cell of said carousel.

5. The automated item dispensing system of claim 1 wherein said dispenser is a temperature controlled dispenser.

6. The automated item dispensing system of claim 5 wherein said temperature controlled dispenser is a room temperature cabinet, incubator, refrigerator or freezer.

7. The automated item dispensing system of claim 6 wherein said temperature controlled cabinet is suitable for dispensing a biological reagent.

8. The automated item dispensing system of claim 1 wherein said local controller performs at least one of the following functions: rotation of the carousel by controlling the motor, controlling dispensing of an item from the dispenser, monitoring an amount of an item within the dispenser, reporting to the central controller the amount of an item within the dispenser, making an activity log and temperature log of the dispenser, informing a user of availability of an item, receiving information from the central controller in relation to item delivery to the dispenser and temperature control setting of the dispenser and monitoring and controlling an internal environment of the dispenser.

9. The automated item dispensing system of claim 1 wherein said local controller further comprises a reader and writer of a dynamic storage device that stores information in relation to the user(s).

10. The automated item dispensing system of claim 9 wherein said dynamic storage device is a transaction card or smart card.

11. The automated item dispensing system of claim 1 wherein said central controller performs at least one of the following functions: advising the user(s) of item availability and item delivery date to the dispenser, monitoring an amount of item within the dispenser, informing the supplier of items purchased by the user(s) and requesting the supplier to provide additional items to replace items dispensed from the dispenser.

12. The automated item dispensing system of claim 1 wherein the local controller and the central controller are each computers.

13. The automated item dispensing system of claim 1 wherein the supplier(s) communicate with the dispenser via the central controller.

14. The automated item dispensing system of claim 1 wherein the communication network is selected from the group consisting of: an intranet, an Ethernet, an Internet, a telephone network, a wireless network and a combination thereof.

15. The automated item dispensing system of claim 1 wherein said motor is attached to the carouse by a shaft located central to the carousel.

16. The automated item dispensing system of claim 1 wherein said motor is located external to the dispenser.

17. The automated item dispensing system of claim 1 wherein the access hatch is lockable.

18. The automated item dispensing system of claim 1 wherein the local controller controls locking and unlocking of the access hatch.

19. Use of the automated item dispensing system of claim 1 to dispense an item located within a cell of the carousel.

20. Use of the automated item dispensing system of claim 19, wherein said item is a biological reagent.

21. Use of the automated item dispensing system of claim 19 wherein a user is capable of determining an abundance of at least one item in the dispenser remotely via email using a communications network linked to the central controller and local controller.

22. Use of the automated item dispensing system of claim 19 wherein the user is capable of determining an abundance of at least one item in the dispenser directly with the local controller through physical interaction with said local controller.

23. Use of the automated item dispensing system of claim 22 wherein said physically interaction is via a keyboard, mouse, touch screen or voice activation.

24. An item dispenser for use with the automated item dispensing system comprising:
(1) an environmentally controlled cabinet;
(2) at least one rotatable carousel located within the cabinet, wherein the carousel comprises a plurality of cells defined by two side walls, each side wall extending from a central location of the carousel;
(3) an access hatch aligned with each rotatable carousel for accessing an interior of the cells;
(4) a motor for rotating the carousel; and
(5) a local controller for controlling rotation of the carousel and
monitoring availability of an item located within a cell of the carousel.

25. The item dispenser of claim 24 wherein the local controller further monitors and controls environmental conditions within the cabinet.

26. The item dispenser of claim 24 wherein the local controller controls locking and unlocking of the access hatch activation.

27. An automated item dispensing system comprising:
(1) an environmentally controlled cabinet;
(2) at least one multiple celled dispenser;
(3) an access hatch aligned with the dispenser for accessing an interior of the cells;
(4) a motor for moving or rotating the dispenser or one or more cells in the dispenser; and
(5) a local controller for controlling movement of the dispenser and monitoring availability of an item located within a cell of the dispenser.

28. A method for automatically dispensing items comprising use of an automated item dispensing system, wherein the automated item dispensing system comprises:
(a) at least one multiple celled dispenser capable of dispensing at least one item, where the multiple celled dispenser comprises (i) multiple cells, (ii) an access hatch aligned with the dispenser for accessing an interior of the cells, (iii) a motor for moving or rotating the dispenser or one or more cells in the dispenser; and (iv) a local controller for controlling movement of the dispenser and monitoring availability of an item located within a cell of the dispenser;
(b) a central controller for receiving and processing electronic item orders from at least one user; and
(c) a communication network for providing communication between said local controller, said central controller, said at least one user and at least one supplier.

29. The method of claim 28, wherein the communication network comprises an intranet, an Ethernet, an Internet, a wireless network, a telephone network, or a combination thereof.
